(19) United States
(12) Patent Application Publication
(10) Pub. No.: US 2002/0191743 A1
(43) Pub. Date: Dec. 19, 2002

(54) Solid-state radiation detector

(76) Inventor: Hartmut Sklebitz, Erlangen (DE)

Correspondence Address: SCHIFF HARDIN & WAITE, 6600 SEARS TOWER, 233 S WACKER DR, CHICAGO, IL, 60606-6473, US

(21) Appl. No.: 10/153,987

(22) Filed: May 23, 2002

(30) Foreign Application Priority Data
May 23, 2001 (DE) 10126388.0

(51) Int. Cl. H05G 1/64

(52) U.S. Cl. 378/98.8

(57) ABSTRACT

A solid-state radiation detector is provided comprising a carrier, a pixel matrix arranged carrier-proximate and a scintillator arranged matrix-proximate for the conversion of the incident radiation into a radiation that can be processed by the pixel matrix. A low-absorption carrier is provided that is arranged at the beam entry side of the solid-state radiation detector.

### BACKGROUND OF THE INVENTION

1. FIELD OF THE INVENTION

The invention is directed to a solid-state radiation detector comprising a carrier, a pixel matrix arranged proximate to the carrier, and a scintillator arranged proximate to the matrix for the conversion of the incident radiation into a radiation that can be processed by the pixel matrix.

2. Description of the Related Art

Solid-state radiation detectors are known and are based on active pixel matrices (panels) made of materials such as amorphous silicon (a-Si). The image information that, for example, is supplied by an X-ray incident onto the solid-state detector that previously passed through a subject to be transirradiated (e.g., a patient) is converted into a radiation that can be processed by the pixel matrix. Such a conversion may take place in a radiation converter in the form of a scintillator layer made of, for example, cesium iodide (Csl), gadolinium oxisulfide (Gd₂O₂S) or selenium (Se). This results in electrical charges being generated and stored in the active pixels of the matrix and these stored charges are subsequently read out with dedicated electronics and post-processed.

Known detectors use a glass substrate carrier that is several millimeters thick on which the pixel matrix is applied. The glass absorbs a considerable number of quanta of the incident radiation (e.g., the X-ray radiation) which is why the carrier in known detectors is arranged at the side facing away from the incident radiation. In known detectors, the incident radiation first strikes the scintillator, and this radiation is converted into the radiation that can be processed by the pixel matrix following the scintillator. The scintillator, also known as a luminescent screen, is brighter at the beam entry side than at the opposite side facing toward the pixel matrix because the X-ray absorption is higher at the beam entry side of the scintillator layer due to the attenuation of the incident X-radiation by the scintillator itself and the additional beam hardening due to the scintillator layer. The radiation part that can be processed by the pixel matrix is thus lower at that side of the scintillator layer facing toward the matrix, which negatively influences -the signal-to-noise ratio. Another disadvantage is that the optical image at that side of the scintillator layer facing toward the matrix is not as sharp as at the beam entry side due to light scatter in the scintillator layer. This leads to a poorer modulation transfer function (MTF).

### SUMMARY OF THE INVENTION

The invention provides a solid-state radiation detector that eliminates these disadvantages by providing a low-absorption carrier that is arranged at the beam entry side of the solid-state radiation detector.

The invention operates based on a completely different irradiation concept. Instead of irradiating the detector from the scintillator side, the inventive radiation detector is irradiated from the other side, and the radiation passes through an inventive low-absorption carrier that absorbs very few quanta. The following pixel matrix is likewise very thin and can be transirradiated without difficulty. The radiation then impinges the scintillator layer immediately adjacent at the pixel matrix and is converted within it. In other words, in the inventive solid-state radiation detector, the beam entry side of the scintillator layer is immediately adjacent to the pixel matrix. Since the scintillator layer is noticeably brighter at the beam entry side and since this is immediately adjacent to the pixel matrix, a clearly higher signal amplitude that leads to an improved signal-to-noise ratio is obtained. Another advantage is that the optical image at the beam entry side of the scintillator layer is clearly sharper, for which reason the inventive radiation detector exhibits a better MTF. The two advantageous effects of the inventive detector that have been described also lead to an improvement of the detective quantum efficiency (DQE) value.

The carrier itself may be composed of a material having an optimally low absorption or may be designed such that its absorption properties are largely minimized. The thickness of the carrier may be ≦1 mm, particularly ≦500 μm; the thicknesses of ≦100 μm, and particularly ≦50 μm, are preferred.

Such thicknesses can be achieved, for example, with a carrier in the form of a film. The carrier itself can, e.g., be made of glass or plastic. Such materials can be manufactured with the desired thickness without difficulty. For example, glass films having thicknesses ≦50 μm can be manufactured.

The invention is particularly effective (especially when using extremely thin carriers) when the carrier is absorbent at least in a sub-range of the spectrum of the radiation that the pixel matrix can process (preferably over the entire spectrum), particularly to the extent it relates to the radiation converted by the scintillator.

This advantageously reduces or minimizes the light coupling in the carrier and thus prevents the carrier from acting as radiation or light conductor, which could have a disadvantageous effect on the charge generation in the pixel matrix. In order to be able to achieve these absorbent properties, a carrier composed of plastic, e.g., can contain radiation-absorbing particles, for example in the form of carbon particles. For a carrier composed of glass, the carrier should advantageously comprise color centers for absorption purposes, these color centers can be generated in the glass using, e.g., high-energy beam exposition with, for example, gamma radiation.

The scintillator can be provided by, for example, a Csl layer This layer can be grown in a needle-like manner on the pixel matrix. An advantage of the inventive radiation detector given Csl scintillators is that many Csl grains arise on the pixel matrix at the start of the deposition, These, however, are not connected to the Csl needles residing essentially vertically to the plane of the pixel matrix in the final condition of the scintillator; furthermore, these grains have no light-conductive connection (or only an unfavorable light-conductive connection) to the Csl needles. These Csl grains are coupled clearly better to the light-sensitive pixel detector matrix due to their position immediately at the beam entry side of the scintillator.

Alternatively, the scintillator can also be in the form of a GdOS layer (gadolinium oxisulfide (Gd₂O₂S)) utilized in a powdered form in which the reversal of the incident direction has an even more advantageous effect in view of an increased signal amplitude (and, thus, an improved signal-to-noise ratio, due to the multiple scatter and absorption events established in this layer structure-conditioned). As a further alternative, a selenium scintillator can also be provided.

In known solid-state radiation detectors, the thick glass carrier also usually has a function of stabilizing the detector. However, the inventive detector using an extremely thin carrier ideally comprises a reinforced housing in order to compensate for the diminished contribution of the thin carrier to the stability of the detector. The housing, in a preferred embodiment, may be composed of carbon fiber plates.

### DESCRIPTION OF THE DRAWING

Further advantages, features and details of the invention are illustrated by the exemplary embodiment described below as well as on the basis of the drawing.

The drawing Figure is a schematic side view of the layer structure in the inventive detector.

### DETAILED DESCRIPTION OF THE INVENTION

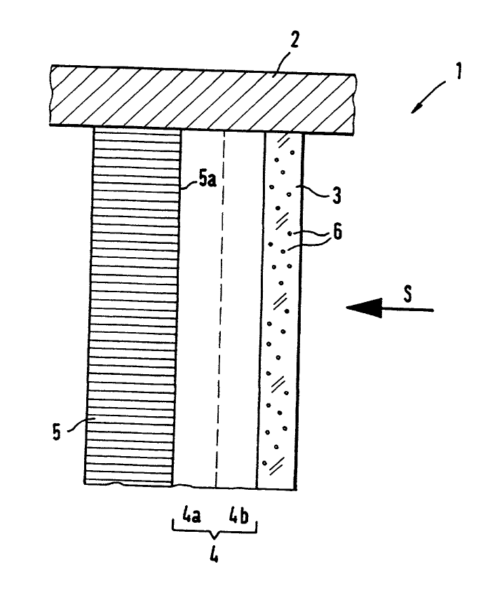

FIG. 1 shows the inventively central portions of an inventive solid-state radiation detector 1. The solid-state radiation detector 1 has a housing 2 of, e.g., carbon fiber plates. The detector comprises a carrier 3 that is very thin —preferably it is a film having a thickness ≦50 μm. In one preferred embodiment, a glass film is employed as carrier 3; such glass films can presently be obtained with a thickness of approximately ≦25 μm. Instead of a glass film, however, a carrier of plastic can also be used. This should also ideally be optimally thin, preferably implemented in the form of a film. Other suitable materials with similar properties may be utilized.

A pixel matrix 4, i.e., the actual detector matrix, is applied on the carrier 3. This matrix, preferably composed of amorphous silicon, comprises a first section 4a that forms the photodiode layer by which the charges, whose plurality is dependent on the incident quantity of radiation, are generated in the photodiodes. The pixel matrix 4 also comprises a switch matrix 4b for the dedicated readout of the photodiodes. The structure of such an a-Si pixel matrix is well known in the art.

A scintillator 5 is applied directly onto the pixel matrix 4. This scintillator is, for example, constructed using needle- shaped Csl; however, a scintillator of GOS or of Se can also be applied.

The employment of the very thin, low-absorption carrier 3 then makes it possible to irradiate the solid-state radiation detector from the other side compared to what is standard in known detectors.

As shown with the arrow S, the detector is irradiated from the side at which the carrier 3 is arranged. The radiation, for example X-ray radiation, penetrates the carrier 3 that, due to its extremely slight thickness or the corresponding selection of material, has an extremely low absorbent effect, i.e. only very few X-ray quanta are absorbed in the carrier. Furthermore, the radiation passes uninfluenced through the pixel matrix 4 to the farthest-reaching extent and is incident onto the scintillator 5, namely at the side 5a that is immediately adjacent to the pixel matrix 4. The X-ray radiation reaching the scintillator 5 is converted into a radiation that can be processed by the pixel matrix 4. The radiation conversion thus occurs immediately adjacent to the pixel matrix. The X-ray radiation is hardly attenuated upon reaching the scintillator layer because a very efficient radiation conversion results from the fact that the scintillator layer is noticeably brighter at the beam entry side than at the beam exit side. The beam entry side 5a is immediately adjacent to the pixel matrix 4 in this case and thus results in clearly higher signal amplitudes as well as a significantly better signal-to-noise ratio upon readout of the individual photodiodes. The conversion-conditioned optical image generated at the beam entry side 5a is also clearly sharper, which leads to a better MTF.

In order to avoid light-conducting properties of the carrier 3, which could potentially have a disadvantageous effect on the charge carrier generation or on the readout behavior of the pixel matrix 4, the carrier 3 should be at least partially absorbent for the converted radiation supplied by the scintillator. Given employment of a carrier 3 formed of plastic or glass, absorption centers 6 are introduced or formed. In the case of a plastic carrier 3, for example, these absorption centers 6 can simply comprise introduced carbon particles. In the case of a glass carrier 3, color centers can be generated for absorption.

As stated, the scintillator can be comprised of needle-shaped Csl or a powder —phosphorous, for example in the form of GOS. The acquisition of the light image acting on the pixel matrix directly at the boundary surface scintillator-pixel matrix offers the further advantage of achieving similarly good or even better DQE results given GdOS scintillators, which can be manufactured clearly more beneficially and less involved than the demanding Csl scintillators, The Csl scintillators are expensive and must be manufactured with great outlay and which, additionally, usually further require a diffusion barrier and which represent a permanent, potential source of danger for the service life of the device.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The particular implementations shown and described herein are illustrative examples of the invention and are not intended to otherwise limit the scope of the invention in any way. Moreover, no item or component is essential to the practice of the invention unless the element is specifically described as “essential” or “critical” Numerous modifications and adaptations will be readily apparent to those skilled in this art without departing from the spirit and scope of the present invention.

### List of Reference Characters

| | |
|---|---|
| 1 | solid-state radiation detector |
| 2 | housing |
| 3 | carrier |
| 4 | pixel matrix |
| 4a | section |
| 4b | switch matrix |
| 5 | scintillator |
| 5a | side |
| 6 | absorption centers |
| S | irradiation direction |

What is claimed is:

1. A solid-state radiation detector comprising:
a carrier arranged at a radiation beam entry side of the detector;
a pixel matrix arranged proximate to the carrier; and
a scintillator arranged proximate to the matrix configured to convert incident radiation into a radiation that can be processed by the pixel matrix.

2. The solid-state radiation detector according to claim 1, wherein the carrier comprises a low-absorption material.

3. The solid-state radiation detector according to claim 1, wherein the carrier is ≦1 mm thick.

4. The solid-state radiation detector according to claim 1, wherein the carrier is ≦500 μm.

5. The solid-state radiation detector according to claim 1, wherein the carrier is ≦100 μm.

6. The solid-state radiation detector according to claim 1, wherein the carrier is ≦50 μm.

7. The solid-state radiation detector according to claim 1, wherein the carrier is a film.

8. The solid-state radiation detector according to claim 1, wherein the carrier is composed of a material that is at least one of glass and plastic.

9. The solid-state radiation detector according to claim 1, wherein the carrier is absorbent at least in a sub-range of a spectrum of the radiation that can be processed by the pixel matrix.

10. The solid-state radiation detector according to claim 9, wherein the carrier is composed of plastic comprises radiation-absorbent particles.

11. The solid-state radiation detector according to claim 10, wherein the radiation-absorbent particles are carbon particles.

12. The solid-state radiation detector according to claim 9, wherein the carrier is composed of glass that comprises color centers.

13. The solid-state radiation detector according to claim 1, wherein the pixel matrix is composed of amorphous silicon.

14. The solid-state radiation detector according to claim 1, wherein the scintillator comprises a CsI layer.

15. The solid-state radiation detector according to claim 1, wherein the scintillator comprises a Gd₂O₂S layer.

16. The solid-state radiation detector according to claim 1, wherein the scintillator comprises an Se layer.

17. The solid-state radiation detector according to claim 1, further comprising a reinforced housing.

18. The solid-state radiation detector according to claim 17, wherein the housing comprises carbon fiber plates.
